(19) United States
(12) Patent Application Publication
(10) Pub. No.: US 2013/0064423 A1
(43) Pub. Date: Mar. 14, 2013

(54) FEATURE EXTRACTION AND PROCESSING FROM SIGNALS OF SENSOR ARRAYS

(71) Applicants: Yvonne JOSEPH, Fellbach (DE); Isabelle RAIBLE, Tuebingen (DE); Mustafa SARPASAN, Stuttgart (DE); Nadejda KRASTEVA, Fellbach (DE); Gabriele NELLES, Stuttgart (DE)

(72) Inventors: Yvonne JOSEPH, Fellbach (DE); Isabelle RAIBLE, Tuebingen (DE); Mustafa SARPASAN, Stuttgart (DE); Nadejda KRASTEVA, Fellbach (DE); Gabriele NELLES, Stuttgart (DE)

(73) Assignee: Sony Corporation, Tokyo (JP)

(21) Appl. No.: 13/587,306

(22) Filed: Aug. 16, 2012

(30) Foreign Application Priority Data
Sep. 9, 2011 (EP) 11007356.6

(51) Int. Cl. G06K 9/46

(52) U.S. Cl. 382/103

(57) ABSTRACT

Feature extraction includes extracting features from signals of a plurality of sensors of a sensor array, including, for each sensor, obtaining a signal of the sensor corresponding to responses of the sensor during one or more exposures to samples, computing a baseline function from the signal, and computing the features based on the baseline function and values corresponding to responses of the sensor during each exposure. Feature vectors are formed from the features of the sensors. The features in each feature vector correspond to the same exposure. At least one of computing the baseline function by interpolating baseline values corresponding to responses of the sensor prior to each exposure, and forming the feature vectors by combining features of at least one sensor with features of at least one redundant sensor of the sensor array in the feature vectors is performed.

### TECHNICAL FIELD

The present invention relates to feature extraction and processing and more particularly to pre-processing of signals encoding features and post-processing of the extracted features.

### BACKGROUND

Feature extraction and processing are well-known techniques in a wide range of applications, like speech and image recognition. Features are generally extracted from a one-, two- or multi-dimensional signal and supplied to pattern recognition algorithms, such as neural networks, in order to determine a pattern or class based on the supplied features. For example, speech recognition may be used to recognize spoken sentences or words from an audio signal. Likewise, image recognition may be used to classify images according to image features. In these application areas, various methods of artificial intelligence have been applied to derive meaningful results from the input signals. Another application of pattern recognition is related to the use of devices which intend to mimic the human nose, the so-called electronic nose devices. Such devices typically comprise an array of sensors responsive to gas samples. In order to identify a single analyte or categorize a group of analytes in a sample, pattern recognition using neural networks is typically employed.

However, the final quality of recognition strongly relies on the extracted features and their processing. Often a pre-processing of signals from the sensors considering the respective sensor characteristics and behaviour, as well as a post-processing of extracted features are typically not addressed by pattern recognition techniques. Also, pattern recognition and feature extraction are often performed only under stable laboratory conditions which generally cannot be reproduced in real-life applications that, for example, imply environmental noise and extreme levels of environmental factors, such as a high level of humidity, changing temperatures and others.

For example, during measurements performed over a defined period of time the baseline of a sensor may be affected, which may not be negligible for the subsequent pattern recognition. Such baseline drifts may be an intrinsic property of the sensor material, e.g. due to aging, or a response to a change in the ambient atmosphere, e.g. increase in temperature or humidity during real-life measurements. Depending on the material and age of the sensor and environmental factors, even during short measurements a drift of the baseline may occur, resulting in false feature values. Also, the time of an exposure of a sensor to a sample may be limited, such that it may not always be possible to wait until particular sensors have been fully saturated. For example, a sensor exposed to a breath sample could have a response time over 10 minutes due to the extremely high humidity in the sample, however, at the same time the amount and duration of the sample may be limited.

As a consequence, the quality of recognition, for example indicated by a recognition rate, may depend on a plurality of factors, such as complexity of the sample, sensor behaviour, e.g. speed of response and cross-sensitivity, on temporal characteristics and environmental conditions, which may lead to unreliable results if not taken into consideration. Current methods for feature extraction for example apply filtering algorithms on the whole set of sensor data, however, do not take further characteristics and conditions of the sensors or the environment into account leading to undesirable deviations and inconsistencies in the extracted feature values and, consequently, a poor recognition rate.

Accordingly, there is a need for a suitable approach to feature extraction and processing that takes the dynamic behaviour and characteristics of sensors as well as environmental conditions into account and which improves the quality and reliability of pattern recognition.

### SUMMARY OF THE INVENTION

It is therefore an object of the present invention to provide a solution for feature extraction and processing, which leads to improved recognition results. In particular, it is an object of the present invention to improve the generation of feature vectors for pattern recognition taking the aforementioned deficiencies into account.

This problem is solved by a method for feature extraction according to claim 1. Furthermore, a computer program product, an apparatus and a system for feature extraction are disclosed in claims 16, 17, and 30, respectively. Preferred embodiments are described in the dependent claims.

According to the invention features are extracted from signals of a plurality of sensors of a sensor array. For each sensor, the feature extraction includes obtaining a signal of the sensor corresponding to responses of the sensor during one or more exposures to samples, computing a baseline function from the signal, and computing the features based on the baseline function and values corresponding to responses of the sensor during each exposure. Furthermore, feature vectors are formed from the features of the sensors, wherein said features in each feature vector correspond to the same exposure. The inventive method further comprises at least one of computing the baseline function by interpolating baseline values corresponding to responses of the sensor prior to each exposure, and forming the feature vectors by combining features of at least one sensor with features of at least one redundant sensor of the sensor array in the feature vectors.

Thus, for each sensor of the sensor array the corresponding signal is analyzed and a baseline function is computed from at least some of the response values of the signal. The baseline function is taken into consideration for computation of the features corresponding to sensor responses during exposures to the samples and, therefore, leads to a reliable series of features characterizing the sensor responses for each exposure. The features of each sensor are thereafter combined in feature vectors, such that each feature vector reflects the overall response of the sensor array during one exposure to a sample. The overall feature extraction and feature vector generation leads to a set of feature vectors which reflect the characteristics and behaviour of the sensors as well as environmental conditions.

The overall quality and reliability of the resulting feature vectors is further improved by interpolating the baseline values used to determine the baseline function and/or by combining the features related to a sensor with features related to a redundant sensor in the feature vectors. Each of these method steps improves the quality of the resulting feature vectors, leading to improved pattern recognition results. In particular, by interpolating the baseline function the resulting features of each sensor are less prone to temporal fluctuations and noise, related to characteristics and behaviour of sensors, due to for example thermal noise in the electric circuitry of the sensors and due to electromagnetic interference or hardware-specific limitations. Hence, the resulting features represent more adequately and consistently analyzable data. Depending on the sensor type the characteristics of the sensor themself may also often incorporate drifts that need to be compensated to provide useable data independent of external influences. However, these characteristics and behaviour of sensors are also alone or in combination addressed by the use of redundant sensors in the sensor array, whose extracted features are combined with features of corresponding sensors in the resulting feature vector data set. Thus, the resulting feature vector data set reflects the variations of environmental conditions and sensor characteristics through redundant features. Therefore, deviations and fluctuations are inhibited, leading to an improved quality of recognition results.

Accordingly, each one of the aforementioned steps alone contributes to the inventive solution of the aforementioned problem by generating a set of reliable feature vectors, reflecting real-life conditions as well as characteristics and features of the sensors, which may advantageously be used for pattern recognition leading to improved recognition results. Yet, it is to be understood that even though both steps may be executed independently to achieve the aforementioned goals, they are also technically linked to each other and may also be exercised in combination to further improve the quality of the feature extraction for pattern recognition.

According to a preferred embodiment of the present invention the signal of each sensor or redundant sensor represents temporal data of responses of the sensor or redundant sensor during a measurement cycle including a plurality of exposures of the sensor to samples. For each sensor the signal may represent a sensor trace, which may represent the sensor response over a period of time. The measurement cycle may for example include 3 or more exposures, preferably 15 to 25 exposures and most preferably 20 exposures of the sensor array to samples. Each exposure may have the same or a different duration and may be followed by an interval, in which the sensor de-saturates and returns to its null-response or baseline response. As an example an exposure may last between 2 to 20 seconds, preferably between 3 and 10 seconds and most preferably 3 seconds. The intervals after exposure may last between 3 to 20 seconds, preferably 4 to 10 seconds, and most preferably 6 seconds. Thus, a typical measurement interval including an exposure and the subsequent de-saturation interval would most preferably last 9 seconds. However, the present invention is not restricted to a particular duration of exposure and intervals.

In a particularly preferred embodiment of the present invention the values corresponding to the responses of the sensor during each exposure are each derived from a temporal average of a response saturation region during the exposure. The start and the end of each exposure may be determined by timing values supplied as auxiliary data or by a discreet signal. Also, the start and the end of each exposure may be characterized by steep rising or falling edges in the response signal of the sensor. Thus, either from the external data or by detection of these edges, for example by differentiating the signal and/or using thresholds, the time duration of the overall exposure to the sample may be determined. Thereafter, at least a part of the exposure time and the corresponding signal values may be defined as the response saturation region. The temporal average of the signal value in this response saturation region may be defined as an average of the response values. For example, the response saturation region may comprise less than 30, preferably 5 to 20, and most preferably 10 values, and the average of these values is used to define the temporal average for the response value. Also, the response saturation region may for example be defined as the last 10% to 80%, preferably the last 20% to 70%, and most preferably the last 30% of the signal during exposure. However, it is to be understood that the signal during the whole exposure may be considered to determine a response value of the signal. Also, several values during one response may be used to define a response value for that exposure. Furthermore, temporal averaging may also be performed by filtering or convoluting the signal with a mean or smoothing filter and by defining a particular position in the signal, for example a central or last value of the response saturation region, as the sensor response for an exposure.

According to a particularly preferred embodiment of the present invention the baseline values are each derived from a temporal average in a reference frame located before the start of the corresponding exposure. Similar to the exposure time the interval between two exposures may be defined by additional timing data or an auxiliary timing signal, such as a discreet signal, and may also be derived from rising and falling edges at the beginning and the end of each exposure. After exposure to a sample a sensor will typically de-saturate and return to its baseline or null-response value. Since the baseline may be subjected to drifts and may also be strongly biased due to the complex processes in the sensors during de-saturation, the response values of the interval between exposures may be averaged. In particular, a reference frame may be defined at the end of each interval directly before the start of the next exposure. The time length of each reference frame may be between 10% and 60%, preferably between 20% and 50% and most preferably a third of the overall time duration of each interval. As a result, a baseline value may correspond to the average value of the reference frame. For example, the reference frame may comprise less than 30 values, preferably 5 to 20 values, and most preferably 10 values, which are averaged to get a single result for the baseline value. Also the temporal data in the reference frame may be filtered or convoluted with a suitable smoothing or averaging filter and the resulting baseline value may be defined as the value of a central or last point in the reference frame. However, it is to be understood that also other values may be used as baseline values after smoothing and/or averaging of the signal in the reference frame. The temporal averaging increases accuracy and compensates undesired spikes as well as noise.

In a preferred embodiment of the present invention the baseline values are interpolated by Lagrange polynomials. The interpolation reflects changes and deviations of the baseline. The degree of the polynomials may depend on the number of exposures within a measurement cycle. For example, a Lagrange polynominal is defined as

$$L ( x ) = {\sum }_{j = 0}^{k} {y}_{j} {l}_{j} ( x )$$

with

$${l}_{j} ( x ) = {\prod }_{{0 \leq m \leq k}_{m \neq j }} \frac{x - {x}_{m}}{{x}_{j} - {x}_{m}} .$$

Even though polynomial interpolation using Lagrange polynomials is preferably applied, it is to be understood that also other interpolation techniques can be used to compute the baseline function.

In a particularly preferred embodiment of the present invention the method further comprises interpolating the baseline values using one or more sliding overlapping frames comprising a number of the baseline values as data points for interpolation. Since for a large number of exposures, interpolation at equally spaced points leads to an increased polynomial oscillation at the edges of the interval the number of exposures corresponding to data points for interpolation needs to be limited. According to embodiments of the invention this phenomenon, also known as Runge's phenomenon, may be omitted by splitting the interpolation domain into sliding, overlapping frames with a defined number of baseline values, such that a targeted coordinate is being placed in the center of a frame while for the calculation of the next targeted coordinates next to the one in the center of the considered frame, the frame shifts by a single, following baseline value, thereby revising the interpolation domain. In each frame the respective baseline values are interpolated, for example using Lagrange polynomials, in order to compute the baseline function for or single values at the coordinates in a region of the frame, such as at the center or at the sides of the frame for a first and last frame. However, other interpolation techniques may also be used to compute the baseline function or single values in each respective frame and the region of coordinates may be adjusted to the particular interpolation technique. The number of baseline values in each frame is preferably less or equal to 8, preferably 3, 4, 5, 6 or 7. Especially for long-term monitoring and in case of reduced quantities of analytes in the samples the use of a sliding, centered frame enables an adequate feature extraction of high quality features leading to better recognition results.

According to a further embodiment of the present invention said computing of a feature includes computing a difference between the respective value corresponding to the response of the sensor during an exposure and a value of the baseline function at a point in time of the exposure. Each response value Rₘₐₓ of the sensor for an exposure may be associated with a point in time tᵢ, for example at the end of the exposure or at the center of the corresponding response saturation region. The baseline function may deliver a corresponding baseline value for that point in time tᵢ. A particular feature F for that exposure may be computed by computing a difference between the response value Rₘₐₓ and a value of the baseline function R_{0fit}(tᵢ), such as F=Rₘₐₓ−R_{0fit}(tᵢ). Yet, it is to be understood that the present invention is not restricted to a particular computation of feature values and the features may be derived differently from the one- or multi-dimensional signals. For example, features may comprise gradients within the response saturation region and other analytical and statistical values. Also, the resulting feature for each exposure may be a multi-dimensional feature tupel F_{Si}=(fᵢ), comprising multiple values fᵢ for a sensor Si. For example, a multi-dimensional feature may comprise several response values of one response saturation region and other dependent data. A feature tuple can be realized for example using a relative change of a sensor value, such as resistance, and a gradient at the end of the response saturation region, for example Fₛ₁=(Fa, Fb) with Fa=Rₘₐₓ(tᵢ)−R_{0fit}(tᵢ) and Fb=(Rₘₐₓ(tᵢ)−R_{0fit}(tᵢ))/(Rₘₐₓ(tᵢ₋₁₀) R_{0fit}(tᵢ₋₁₀)). A corresponding feature vector V could then incorporate feature tuples for different sensors S1, S2, S3, . . . , yielding V=(F_{S1}, F_{S2}, F_{S3}, . . . ). The signal of each sensor may therefore be advantageously narrowed down to an amount of features which represent the relevant information suitably for pattern recognition.

According to a further embodiment of the present invention the method further comprises, for each sensor, extracting features from signals of one or more corresponding redundant sensor, and combining the features of the sensors with features of the redundant sensors in feature vectors, said features in each feature vector corresponding to the same exposure, wherein each value of a feature vector is either a feature of one of the sensors or a feature of one of the corresponding redundant sensors. In order to compute a feature vector data set current approaches often include artificially generated data in the feature vectors, for example by doubling the data or including random values. However, the resulting data sets typically do not reflect environmental variations and sensor characteristics and behaviour and therefore do not lead to satisfactory recognition results. According to embodiments of the invention, these problems may be handled through sensor redundancy. Preferably, sensor arrays are used which include for each sensor at least one redundant sensor. The features derived form sensors may be combined with features derived from redundant sensors to form additional feature vectors for each exposure, thereby increasing the feature vector data set with data based on sensor signals that reflects sensor and environmental conditions and therefore leads to an improved quality of pattern recognition on training and validation side, such that not only the training set but also the validation and testing set can be increased based on real rather than synthetic values. Furthermore, sensor redundancy may be used for hardware and/or software sided automated analysis and control.

Preferably, the number of feature vectors corresponding to an exposure is (r+1)^{k}, wherein k is the number of sensors and r is the number of redundant sensors for each sensor. For example, the sensor array may comprise a case depending number of different types of sensors S₁, . . . , Sₖ and each sensor Sᵢ may have corresponding redundant sensors R_{i,1}, . . . , R_{i,r}. Thus, during exposure the sets of sensors Sᵢ and redundant sensors R_{i,j} deliver one feature vector (sᵢ, . . . , sₖ) for the sensors and r feature vectors (r_{1,1}, . . . , r_{k,1}), . . . , (r_{1,r}, . . . , r_{k,r}) for each set of redundant sensors, resulting in (r+1) feature vectors. In addition a large group of auxiliary feature vectors is generated by selecting for each value of an auxiliary feature vector either a corresponding value sᵢ of the feature vector (s₁, . . . , sₖ) or one of the values r_{i,j} of the related feature vectors (r_{1,1}, . . . , r_{k,1}), . . . , (r_{1,r}, . . . , r_{k,r}). Thus each value aᵢ of an auxiliary feature vector (a₁, . . . , aₖ) is chosen from the set {sᵢ, r_{i,l}, . . . , r_{i,r}}. Therefore, including all possible combinations the resulting data set comprises (r+1)^{k} feature vectors.

In a further preferred embodiment of the present invention, the method further comprises, for each sensor, monitoring a number of features corresponding to a number of consecutive exposures and invalidating at least one of the features based on a result of a majority voting performed on the number of features. Typically, a measurement cycle may consist of several exposures of the sensor array to samples. Therefore, the dynamic and temporal sensor characteristics may also be monitored for each sensor individually during the measurement cycle. If, for example, during one exposure a sensor does not reach saturation within the predefined exposure time, this may be recognized and handled appropriately, such as by analyzing a sequence of features by a majority voting system, which may exclude deficient feature values by out-voting. The use of modular redundancy for each sensor increases the quality of the resulting data, since runaway values and outliers may be efficiently invalidated and therefore do not affect the overall recognition quality.

Preferably, the number of consecutive exposures is 3 to 10, preferably 3 to 6, and most preferably 3. For example, in long-term measurement, three consecutive exposures could be monitored and analyzed, which could be regarded as a triple modular redundancy.

In a further particularly preferred embodiment of the present invention the method further comprises reducing the dimensionality of the feature vectors by performing one of a Principle Component Analysis (PCA), a Linear Discriminant Analysis (LDA), and a Kernel Discriminant Analysis (KDA). Even though, as mentioned above, features are extracted from the signals of sensors and/or redundant sensors in order to reduce the sensor input data to meaningful values, the feature vector space dimension is preferably further reduced. PCA uses an orthogonal transformation to convert a set of possibly correlated variables into a set of values of uncorrelated variables or principle components, wherein the first principle component has the highest variance. Thus, after application of the dimensionality reduction, each feature vector F=(fₗ, . . . , fₘ) is reduced to a feature vector G=(gₗ, . . . , gₘ), wherein the first components, for example gₗ, . . . , gₙ, n<m, include most of the information of the feature and, therefore, components gₙ₊₁, . . . , gₘ may be disregarded in further analysis steps. KDA, which is also known as Kernel Fisher Discriminant Analysis, is a non-linear generalization of LDA using the kernel trick, wherein the originally linear operations of LDA are done in a reproducing kernel Hilbert space with a non-linear mapping. The kernel trick involves a replacement of dot product with a kernel function K(x, y)=<φ(x),φ(y)>, defined for example as a Linear kernel k(x, y)=x^{T} y+c, Gaussian kernel,

$$k ( x , y ) = {e}^{- \frac{{‖ x - y ‖}^{2}}{2 {σ}^{2}}}$$

Laplacian kernel

$$k ( x , y ) = {e}^{- \frac{‖ x - y ‖}{σ}} ,$$

as well as other kernel functions and variations and combinations thereof.

In a particularly preferred embodiment of the present invention the method further comprises recognizing patterns based on the feature vectors.

Preferably, said pattern recognition comprises at least one of performing a k-nearest neighbor algorithm on the feature vectors, using a multi layer perceptron (MLP) artificial neural network (ANN) with back propagation learning, and performing multi kernel learning (MKL) with support vector machines (SVM). Neural networks are well-known in the art for pattern recognition. However, ANNs are typically trained with an artificially generated or augmented set of training feature vectors. According to embodiments of the present invention additional feature vectors are derived from combinations of features from sensors with features from redundant sensors, which are thereafter, after dimensionality reduction, supplied to a multilayer perceptron artificial neural network with back propagation learning. Since the input data reflects the environmental and sensor conditions, the enlarged set of feature vectors leads to better and more stable recognition results.

In another embodiment of the present invention the sensor array comprises gas sensors. Preferably, the gas sensor array may form a device also known in the art as an electronic nose, which is intended to mimic the human nose.

In a particularly preferred embodiment of the present invention at least some of the gas sensors include composites of metal nanoparticles and organic linkers. Such sensors allow a fast response time to gas samples and show a very high sensitivity in laboratory conditions. By tuning the chemical composition of the materials of the sensors, the chemical sensitivity/selectivity to target analytes may be specifically tuned. For example, an array comprising several gas sensors may be capable of discriminating between different chemical classes. However, it is to be understood that the present invention is not restricted to the use of gas sensors only. Instead, any suitable array of sensors could be used, for example including optical, acoustical and haptical sensors to name some, as well as their combinations.

Furthermore, according to the present invention, a computer program product comprising one or more computer-readable media having program code means stored thereon is provided, wherein said program code means, when installed and executed on an automated feature extraction apparatus, configure the apparatus to perform a method according to one of the embodiments of the present invention. Preferably, said program code means may be either directly read by the automated feature extraction apparatus or by a coupled computing device, which may execute the program code means, thereby configuring the apparatus to perform the inventive method. For example, the apparatus may comprise programmable hardware and the program code means may comprise code specifically targeted for the hardware. Also, the apparatus may comprise a processing unit executing a compiler and receiving program code means comprising program code. The compiler may compile the program code for the apparatus and execute the code in order to configure the apparatus. Some of the media or the program code means stored thereon may also be transferred to a device including the corresponding sensor array and the device may configure the sensor array to deliver the respective sensor signals to the apparatus.

Furthermore, an apparatus for feature extraction according to the present invention comprises a signal processing unit coupled to a sensor array and configured to extract features from signals of a plurality of sensors of the sensor array. The signal processing unit includes a receiver configured to obtain, for each sensor, a signal of the sensor corresponding to responses of the sensor during one or more exposures to samples and a feature extraction module configured to, for each sensor, compute a baseline function from the signal and compute the features based on the baseline function and values corresponding to responses of the sensor during each exposure. The inventive apparatus further comprises a data processing unit coupled to the signal processing unit and configured to form feature vectors from the features of the sensors, wherein said features in each feature vector correspond to the same exposure. The apparatus also comprises at least one of a processing component of the feature extraction module, configured to compute the baseline function by interpreting baseline values corresponding to responses of the sensor prior to each exposure, and a data module of the data processing unit configured to form the feature vectors by combining features of at least one sensor with features of at least one redundant sensor of the sensor array in the feature vectors.

The inventive apparatus improves the quality of feature recognition by generating feature vectors that better reflect environmental conditions and feature characteristics and behaviour. The signal processing unit or the data processing unit or both further comprise specific elements, which increase the quality and reliability of the extracted features and resulting feature vectors, leading to a better recognition rate as well as stable and reliable results.

In a preferred embodiment of the present invention the signal of each sensor or redundant sensor represents temporary data of responses of the sensor or redundant sensor during a measurement cycle including a plurality of exposures of the sensor to samples.

In a further embodiment of the present invention the values corresponding to the responses of the sensor during each exposure are each derived from a temporal average of a response saturation region during the exposure. For example, the temporal average may be computed from a data frame at the end of the response saturation region during each exposure.

In another embodiment of the present invention the baseline values are each derived from a temporal average in a reference frame located before the start of the corresponding exposure. These values may be used in a polynomial equation for interpolating target coordinates.

According to a preferred embodiment of the present invention the baseline values are interpolated by Lagrange polynomials. However, it is to be understood that also other interpolation algorithms may be used and the present invention is not limited to Lagrange polynomials only.

In a particularly preferred embodiment of the present invention the feature extraction module is further configured to interpolate the baseline values using one or more sliding overlapping frames comprising a number of the baseline values as data points for interpolation. Preferably, each frame comprises a number of the nearest baseline values. Each frame may comprise equal to or less than 8, preferably between 3 and 7, and most preferably 5 baseline values, depending on the number of total exposures within one measurement cycle.

According to a further embodiment of the present invention the feature extraction module is further configured to compute a feature by computing a difference between the respective value corresponding to the response of the sensor during an exposure and a value of the baseline function at a point in time of the exposure.

In a particularly preferred embodiment of the present invention said signal processing unit is further configured to extract, for each sensor, features from signals of one or more redundant sensors, wherein said data module is further configured to combine the features of the sensors with features of the redundant sensors in feature vectors, said features in each feature vector corresponding to the same exposure, wherein each value of a feature vector is either a feature of one of the sensors or a feature of one of the corresponding redundant sensors of the sensor. The redundant sensors may be identical to the corresponding sensor and/or may have the same characteristics and behaviour. At least some of the redundant sensors may be placed adjacent to the corresponding sensor in the sensor array. Alternatively or in combination, at least some of the redundant sensors may be placed apart from the corresponding sensor in the sensor array. Thus, the placement of sensors and redundant sensors may be chosen to reflect the environmental characteristics and characteristics of the sample.

In yet another embodiment of the present invention the number of feature vectors corresponding to an exposure is (r+1)^{k}, wherein k is the number of sensors and r is the number of redundant sensors for each sensor.

In yet another embodiment of the present invention said signal processing unit is further configured to monitor, for each sensor, a number of features corresponding to a number of consecutive exposures and to invalidate at least one of the features based on a result of a majority voting performed on the number of features. Preferably, the number of consecutive exposures to the analyte is 3 to 10, preferably 3 to 6, and most preferably 3. However, it is to be understood that the number of consecutive exposures does not limit or influence the overall number of exposures during one measurement cycle.

In yet another embodiment of the present invention said data processing unit is further configured to reduce the dimensionality of the feature vectors by performing one of a Principle Component Analysis (PCA), a Linear Discriminat Analysis (LDA), and a Kernel Discriminat Analysis (KDA).

In a particularly preferred embodiment of the present invention the apparatus further comprises a pattern recognition unit coupled to the data processing unit, which is configured to recognize patterns based on the feature vectors.

According to an embodiment of the present invention said pattern recognition unit comprises at least one of a module to perform a k nearest neighbor algorithm on the feature vectors, a multi layer perceptron (MLP) artificial neural network (ANN) with back propagation learning, and a multi-class kernel support vector machines (SVM) used with data obtained by multi kernel learning (MKL).

Furthermore, according to the present invention a system for feature extraction comprises a sensor array including a plurality of sensors and an apparatus according to an embodiment of the present invention, wherein said apparatus is coupled to the sensor array and configured to extract features from signals of sensors of the sensor array.

In a particularly preferred embodiment of the present invention the sensor array comprises gas sensors. The gas sensors may be for example based on conducting polymer sensors, on metal oxide sensors or on composites of carbon black and polymer.

According to a further embodiment of the present invention at least some of the gas sensors include composite of metal nanoparticles and organic linkers. Preferably, the systems constitutes an electronic nose device.

### BRIEF DESCRIPTION OF THE DRAWINGS

Further details and characteristics of the invention are described below in exemplifying embodiments of the invention in conjunction with the drawings in which:

FIG. 1 shows a plot of a sensor trace of a sensor, which is used to extract features according to an embodiment of the present invention;

FIG. 2 is a flow diagram of a method for feature extraction according to an embodiment of the present invention,

FIG. 3 depicts the computation of baseline values and response values of a signal according to an embodiment of the present invention,

FIG. 4 shows an application of a sliding frame for interpolation of the baseline values according to an embodiment of the present invention,

FIG. 5 shows a result of an interpolation performed according to an embodiment of the present invention,

FIG. 6 shows a system for feature extraction according to an embodiment of the present invention; and

FIG. 7 shows results of a PCA transformation of feature vectors according to an embodiment of the present invention.

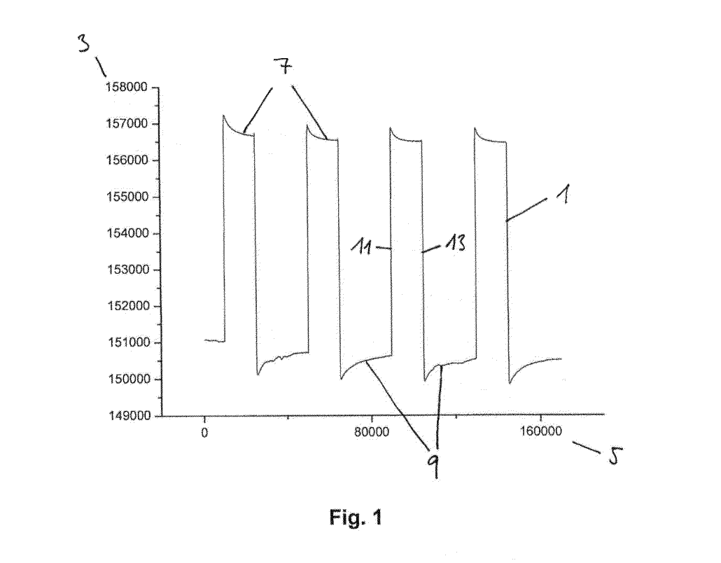

FIG. 1 shows a graph of a sensor trace 1 or signal from a sensor, which shows a response 3 of the sensor, depicted as a change of resistance in Ω, in a measurement cycle 5 (values given in milliseconds). The sensor trace 1 shows four exposures 7 of the sensor to samples and five regions 9 between or after each exposure, where the sensor de-saturates and returns to a null-response or baseline. However, the values of regions 9 are decreasing or drifting over time. Furthermore, the sensor trace 1 shows several peaks, additional noise and fluctuations during exposure 7 and in regions 9, which result from complex saturation and de-saturation processes within the respective sensors as a reaction of the sensor to a particular analyte and/or sample. Each region 9 and the exposures 7 are marked by steep rising and falling edges 11, 13 before and after each exposure 7. Correspondingly, the regions of exposure 7 may be for example identified by detecting edges 11, 13, such as by differentiating the sensor trace 1 or by using suitable thresholds.

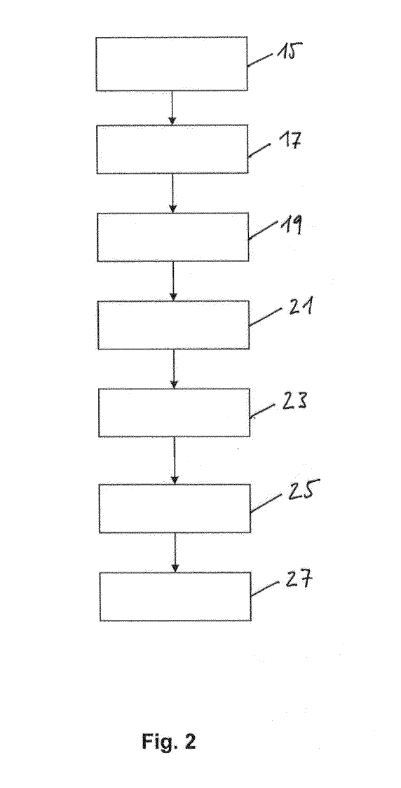

FIG. 2 shows a flow chart of a method for feature extraction according to an embodiment of the present invention. In a first step 15 a partial mean filtering of sensor traces, for example sensor trace 1 of FIG. 1, is performed. Preferably, each sensor trace is mean filtered at a reference coordinate frame before the start of exposure as well as during exposure, such as in regions 7 and 9 of FIG. 1. In a consecutive step 17 the baseline values are interpolated using Lagrange polynomials yielding a baseline function. For each exposure a feature is extracted from the signal in step 19 by computing a difference between the response value and the corresponding value of the baseline function at the same point in time. For example, a feature may represent a relative change in resistance of the respective sensor at the saturation region. Thus, the feature extraction of step 19 results in a series of features for each sensor of the sensor array. This series is analyzed in step 21, wherein a majority voting system is used to detect deficient feature values by out-voting.

In step 23 the features from the plurality of sensors for each exposure are formed to feature vectors. In each feature vector the features of sensors as well as the features of redundant sensors may be considered, resulting in feature vectors directly originating from either the sensors or the redundant sensors, or in additional feature vectors, including a combination of features of both. The additional feature vectors are formed such that each value of an additional feature vector is selected to be either a feature of a sensor or a feature of a redundant sensor. For example, assuming that a feature vector A comprises the features of three sensors for one exposure A=(a1, a2, a3) and a feature vector B comprises the redundant counterpart B=(b1, b2, b3) resulting from a sensor array of three sensors and one corresponding redundant sensor per sensor. The additional feature vectors, wherein each element is either an element of feature vector A or a corresponding element of feature vector B, are defined as the following feature vectors: (a1, a2, b3), (a1, b2, a3), (a1, b2, b3), (b1, a2, a3), (b1, a2, b2), and (b1, b2, a3). In general, the number of additional feature vectors depends on the number of sensors k and the number of redundant sensors r per sensor in the sensor array. If all direct feature vectors and additional feature vectors are used, the overall number of feature vectors amounts to (r+1)^{k}. For example in the case of 15 different sensors and one redundant sensor per sensor, the number of feature vectors including all additional feature vectors increases to 2¹⁵=31768 feature vectors.

After generation of feature vectors in the data set in step 23, the dimensionality of the feature vectors is reduced in step 25, for example, by transforming the feature vectors using Principle Component Analysis (PCA) or Kernel Discriminant Analysis (KDA). Thereafter, only a certain number of dimensions from the resulting transformed feature vectors may be used for further analysis. In step 27, the resulting data set of reduced dimensionality is used for pattern recognition. For example, the reduced feature vectors may be fed into a multi layer perceptron (MLP) artificial neural network (ANN) with back propagation learning. Also, one part of the data set may be used to train the ANN while another part may be used to validate the trained network.

Even though, the method of FIG. 2 has been shown with particular method steps in a particular order it is to be understood that the present invention is not restricted to particular method steps or a particular ordering of the steps. Rather, the present invention may comprise other and additional processing steps and also some of the steps may be omitted. Also, some of the processing may be performed concurrently. For example steps 25 and 27 may be omitted and optionally support vector machines (SVM) in combination with multi kernel learning (MKL) may be used for pattern recognition instead of dimensionality reduction with PCA and/or KDA and the use of LMP ANN with back propagation learning.

Support Vector Machines (SVM) are sets of related supervised learning methods which can be used for linear classification between two classes. To be able to use SVMs as non-linear classifiers the kernel trick may be applied in the same way as for Kernel Discriminant Analysis (KDA) enabling the transformation of the algorithm into a higher-dimensional space without mapping the input coordinates into this space. Unlike KDA this still does only allow classification between two classes at once as SVMs are binary classifiers. To achieve multi-class classification using SVMs the total classification process may be divided into sub-problems each consisting of a binary classifier. The winning class is then identified by majority voting, also called one-against-one strategy for multi-class classification.

A decision problem between n classes can be decomposed in a small subset of n(n−1)/2 binary problems. For example, a discrimination between 3 classes C1, C2, C3 may require 3(3−1)/2=3 binary classifiers comparing C1 with C2, C2 with C3 and C1 with C3. For example, for given classes C1, C2 and C3 a comparison of C1×C2 may lead to C2 as the winner of the sub-problem. C2×C3 may lead to C3 as the winner of this sub-problem and, finally, C1×C3 may as well result in C3 as the winner of the sub-problem. Consequently, the winner of the example multi-class classification process would be C3. Multi-class kernel SVMs may be advantageously used as an alternative to KDA combined with Artificial Neural Networks (ANN) for pattern recognition, in particular with gas sensors and/or an electronic nose device. However, the present invention is not restricted to a particular pattern recognition technique or sensor device.

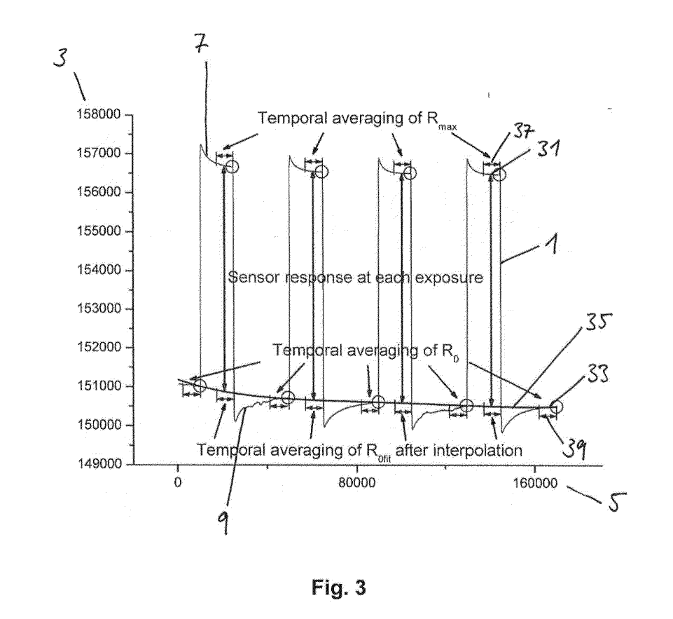

FIG. 3 shows a graph of the sensor trace of FIG. 1 illustrating a computation of signal values according to an embodiment of the present invention. Correspondingly, elements of FIG. 3 corresponding to elements of FIG. 1 are denoted by the same reference numbers as in FIG. 1. FIG. 3 shows a temporal averaging of response values Rₘₐₓ 31 and temporal averaging of baseline values R₀ 33, which are used to compute a baseline function 35. Both, the response values Rₘₐₓ 31 and the baseline values R₀ 33 are determined from the sensor trace 1 by analyzing particular regions of the sensor trace 1 and averaging the data of the regions. In particular, response values Rₘₐₓ 31 are determined from the values of a response saturation region 37 and the baseline values R₀ 33 are determined from the values of a reference frame 39. As shown, the resulting values 31, 33 may correspond to the mean value of the respective regions. For example, the averaged baseline values 33 R₀ for each exposure e may be defined as

$${R}_{0} [ e ] = \frac{1}{a} \cdot {\sum }_{n ∈ I [ e ]} r [ n ] ,$$

wherein r[n] are the response values of one sensor at index n and a is the number of values for averaging in the reference frame defined by I[e] before exposure e. Correspondingly, the averaged response values 31 Rₘₐₓ for each exposure e may be defined as

$${R}_{max} [ e ] = \frac{1}{a} \cdot {\sum }_{n ∈ J [ e ]} r [ n ] ,$$

wherein J[e] relates to responses in a response saturation region 37. The baseline values 33 may be interpolated and used to define the baseline function 35. For each exposure, a corresponding feature value is determined as a difference between the response value Rₘₐₓ 31 and a corresponding value of the baseline function 35 at the same point in time R_{0fit}.

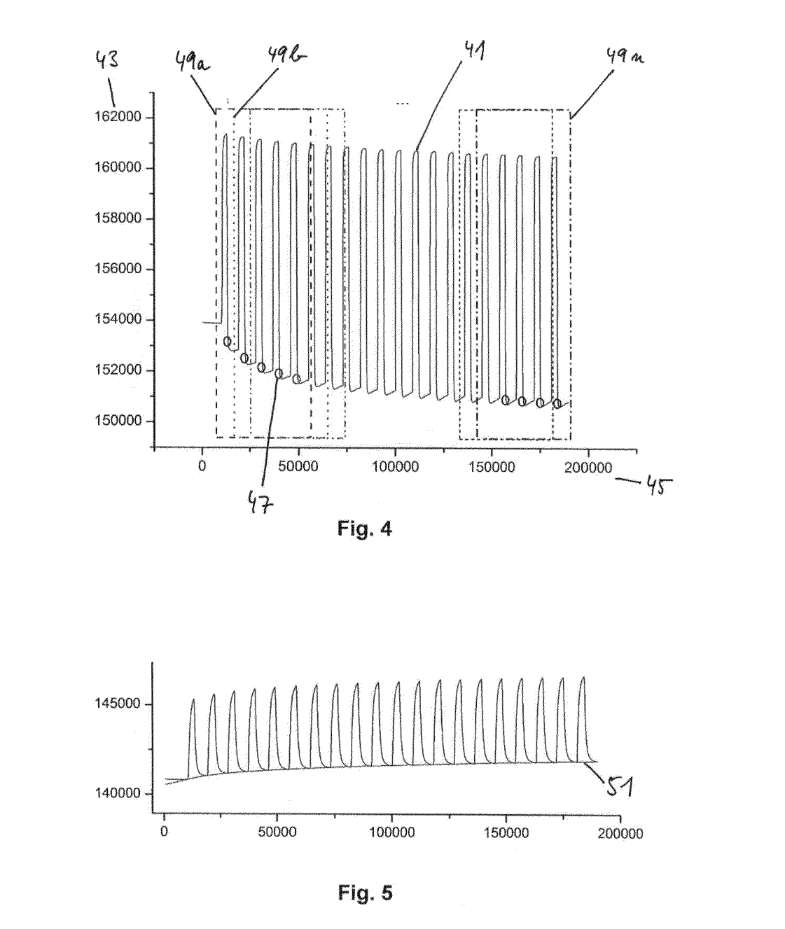

The interpolation of baseline values, as for example depicted in FIG. 3, may preferably be performed by using sliding frames, which define the set of baseline values used for interpolation, as shown in FIG. 4 according to an embodiment of the present invention. FIG. 4 shows a graph of a sensor trace 41 representing sensor values 43 (given as resistance in Ω) in a particular measurement cycle 45 (values given in milliseconds). From the sensor trace 41, the baseline values 47 are determined, for example as described with regard to FIG. 3. However, instead of considering the whole set of baseline values 47 only a limited set of baseline values 47 as defined by sliding frames 49a, 49b, . . . , 49n are used to interpolate a part of the baseline function. Thus, the measurement cycle 45 may be split into intervals of sliding, overlapping frames 49a, . . . , 49n which may preferably comprise a maximum of 8 points, for example 5 baseline values. The target coordinates are preferably placed in the center of a frame. Thus, for a calculation of the next target coordinate the frame may possibly shift by a single, following point, such that the set of data points for interpolation may be revised and may include the next baseline value 47. At the same time, the leftmost baseline value 47 is excluded from the interpolation. Each frame may be used for a Lagrange polynomial interpolation for the coordinates in the range of the frame. Preferably, always the coordinates in the center of each frame are interpolated. Only at the beginning and the end of the measurement cycle 45 the same frame 49a, 49n has to be used to interpolate the first and last sections of the baseline function. The interpolation of FIG. 4 results in a baseline function 51 as shown in FIG. 5. Obviously, baseline function 51 is an optimal interpolation of baseline values and does not include any oscillations in the beginning and/or at the end of the measurement cycle.

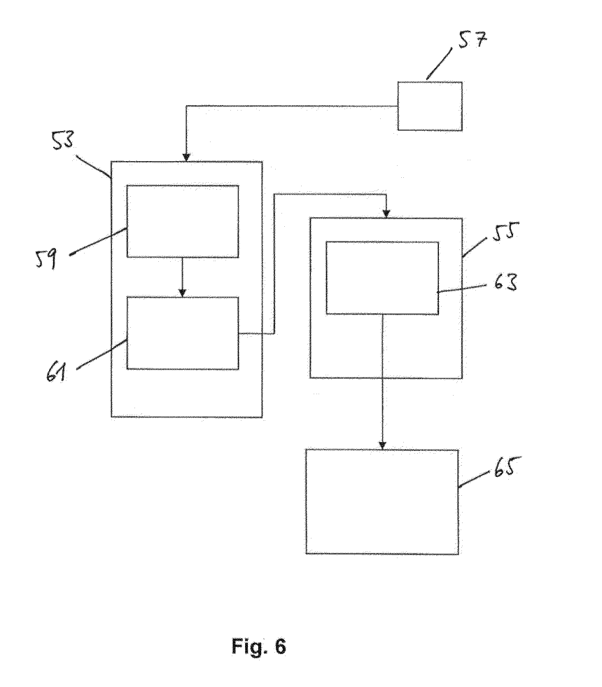

FIG. 6 shows a schematic illustration of an apparatus for feature extraction according to an embodiment of the present invention. The apparatus comprises a signal processing unit 53 and a data processing unit 55. The signal processing unit 53 is coupled to a sensor array 57, preferably comprising a plurality of sensors and corresponding redundant sensors. The signal processing unit 53 receives signals from the sensor array 57, wherein each signal corresponds to a particular sensor or redundant sensor.

The signal processing unit 53 may comprise a receiver 59, which may receive and store the signal for each respective sensor. Correspondingly, the signal processing unit 53 may cornprise memory buffers or other means for storing the received signals for offline processing. Furthermore, the signal processing unit 53 may comprise a feature extraction module 61 which is configured to compute baseline functions from each signal and to compute the features from each signal based on the baseline function and values corresponding to responses of the sensor during each exposure. The feature extraction module 61 may further comprise a processing component which is configured to compute the baseline function by interpolating baseline values corresponding to responses of the sensor prior to each exposure.

The features extracted by the feature extraction module 61 are thereafter provided to the data processing unit 55 which generates feature vectors from the particular extracted features. Preferably, the data processing unit 55 comprises a data module 63 that forms the feature vectors by combining features of at least one sensor with features of at least one redundant sensor of the sensor array in feature vectors, such that features in each feature vector correspond to the same exposure. Thus, by improving the extraction of the features in the signal processing unit 53 and the generation of feature vectors in the data processing unit 55, the resulting feature vectors have and increased quality, are more reliable and lead to an improved recognition results of pattern recognition, which is performed by pattern recognition unit 65.

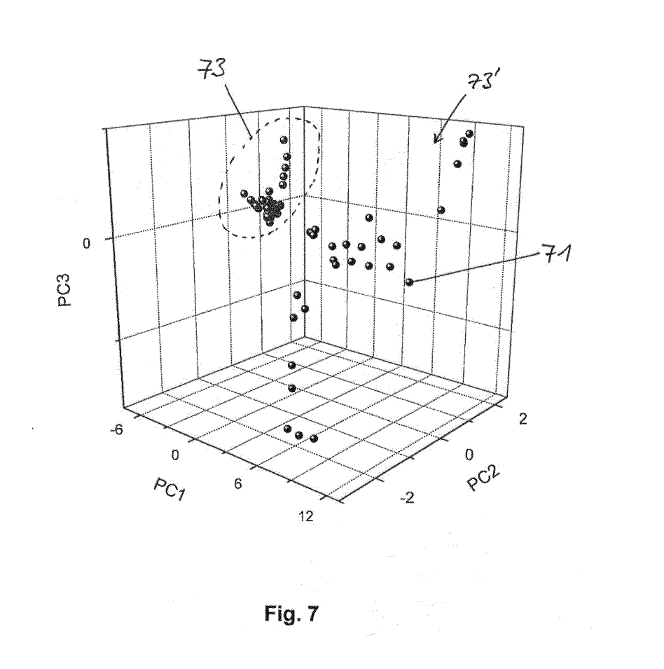

FIG. 7 shows a graph of results of a dimensionality reduction of the resulting feature vector data set performed using a Principal Component Analysis (PCA) according to an embodiment of the present invention. The graph shows the first three principal components PC1, PC2, PC3 and some of the transformed feature vectors 71 determined through the analysis of the feature vector data set. The principle components PC1, PC2, PC3 have the largest possible variance with regard to the feature vectors 71. Thus even after truncation of all other components, the respective feature vectors 71 represent the necessary information to distinguish two different groups 73, 73′ of feature vectors 71. For example, the shown feature vectors 71 represent the resulting features of a gas sensor array exposed to breath samples of a group of smokers and non-smokers. By application of the feature extraction method according to an embodiment of the present invention, the group of smokers 73 may be clearly distinguished from the group of non-smokers 73′.

Even though exemplifying embodiments of the present invention have been described with gas sensors, the present invention is not limited to an application of such sensors. Rather, other sensors and signals derived from a variety of sensors can be analyzed with methods according to embodiments of the present invention. Also, even though the inventive approach has been described with regard to exemplifying embodiments, various modifications may be carried out on the described methods and apparatuses according to embodiments of the present invention. Also, features of the examples may be combined, omitted or added in any suitable way and may be of importance for the invention in any combination. Consequently, the invention may be practiced within the scope of the claims differently from the examples described.

1. A method for feature extraction, comprising the steps of:
extracting (19) features from signals of a plurality of sensors of a sensor array, including, for each sensor, the steps of:
obtaining a signal of the sensor corresponding to responses of the sensor during one or more exposures to samples,
computing a baseline function from the signal, and
computing the features based on the baseline function and values corresponding to responses of the sensor during each exposure; and
forming feature vectors from the features of the sensors, said features in each feature vector corresponding to the same exposure,
wherein the method further comprises at least one of:
computing the baseline function by interpolating (17) baseline values corresponding to responses of the sensor prior to each exposure; and
forming the feature vectors by combining (23) features of at least one sensor with features of at least one redundant sensor of the sensor array in the feature vectors.

2. The method according to claim 1, wherein the signal of each sensor or redundant sensor represents temporal data of responses of the sensor or redundant sensor during a measurement cycle including a plurality of exposures of the sensor to samples.

3. The method according to claim 1, wherein the values corresponding to the responses of the sensor during each exposure are each derived from a temporal average of a response saturation region during the exposure.

4. The method according to claim 1, wherein the baseline values are each derived from a temporal average in a reference frame located before the start of the corresponding exposure.

5. The method according to claim 1, wherein the baseline values are interpolated by Lagrange polynomials.

6. The method according to claim 1, further comprising interpolating the baseline values using one or more sliding overlapping frames comprising a number of the baseline values.

7. The method according to claim 1, wherein computing a feature includes computing a difference between the respective value corresponding to the response of the sensor during an exposure and a value of the baseline function at a point in time of the exposure.

8. The method according to claim 1, further comprising, for each sensor, extracting features from signals of one or more redundant sensors, and combining the features of the sensors with features of the redundant sensors in feature vectors, said features in each feature vector corresponding to the same exposure, wherein each value of a feature vector is either a feature of one of the sensors or a feature of one of the corresponding redundant sensors.

9. The method according to claim 8, wherein the number of feature vectors corresponding to an exposure is (r+1)^{k}, wherein k is the number of sensors and r is the number of redundant sensors for each sensor.

10. The method according to claim 1, further comprising, for each sensor, monitoring (21) a number of features corresponding to a number of consecutive exposures and invalidating one of the features based on a result of a majority voting performed on the number of features.

11. The method according to claim 1, further comprising reducing (25) the dimensionality of the feature vectors by performing one of a Principal Component Analysis (PCA), a Linear Discriminant Analysis (LDA), and a Kernel Discriminant Analysis (KDA).

12. The method according to claim 1, further comprising recognizing (27) patterns based on the feature vectors.

13. The method according to claim 12, wherein said pattern recognition comprises at least one of performing a k-nearest neighbor algorithm on the feature vectors, using a multi layer perceptron (MLP) artificial neural network (ANN) with back propagation learning, and performing multi kernel learning (MKL) with Support Vector Machines (SVM).

14. The method according to claim 1, wherein the sensor array comprises gas sensors.

15. The method according to claim 14, wherein at least some of the gas sensors include composites of metal nanoparticles and organic linkers.

16. A computer program product comprising one or more computer-readable media having program code means stored thereon, wherein said program code means when installed and executed on an automated feature extraction apparatus, configure the apparatus to perform a method according to claim 1.

17. An apparatus for feature extraction, comprising:
a signal processing unit (53) coupled to a sensor array (57) and configured to extract features from signals of a plurality of sensors of the sensor array (57), the signal processing unit (53) including:
a receiver (59) configured to obtain, for each sensor, a signal of the sensor corresponding to responses of the sensor during one or more exposures to samples, and
a feature extraction module (61) configured to, for each sensor, compute a baseline function from the signal, and compute the features based on the baseline function and values corresponding to responses of the sensor during each exposure; and
a data processing unit (55) coupled to the signal processing unit (53) and configured to form feature vectors from the features of the sensors, said features in each feature vector corresponding to the same exposure,
wherein the apparatus further comprises at least one of:
a processing component of the feature extraction module (59), configured to compute the baseline function by interpolating baseline values corresponding to responses of the sensor prior to each exposure; and
a data module (63) of the data processing unit (55) configured to form the feature vectors by combining features of at least one sensor with features of at least one redundant sensor of the sensor array in the feature vectors.

18. The apparatus according to claim 17, wherein the signal of each sensor or redundant sensor represents temporal data of responses of the sensor or redundant sensor during a measurement cycle including a plurality of exposures of the sensor to samples.

19. The apparatus according to claim 17, wherein the values corresponding to the responses of the sensor during each exposure are each derived from a temporal average of a response saturation region during the exposure.

20. The apparatus according to claim 17, wherein the baseline values are each derived from a temporal average in a reference frame located before the start of the corresponding exposure.

21. The apparatus according to claim 17, wherein the baseline values are interpolated by Lagrange polynomials.

22. The apparatus according to claim 17, wherein the feature extraction module (59) is further configured to interpolate the baseline values using one or more sliding overlapping frames comprising a number of the baseline values.

23. The apparatus according to claim 17, wherein the feature extraction module (59) is further configure to compute a feature by computing a difference between the respective value corresponding to the response of the sensor during an exposure and a value of the baseline function at a point in time of the exposure.

24. The apparatus according to claim 17, said signal processing unit (53) being further configured to extract, for each sensor, features from signals of one or more redundant sensors, wherein said data module is further configured to combine the features of the sensors with features of the redundant sensors in feature vectors, said features in each feature vector corresponding to the same exposure, wherein each value of a feature vector is either a feature of one of the sensors or a feature of one of the corresponding redundant sensors.

25. The apparatus according to claim 24, wherein the number of feature vectors corresponding to an exposure is (r+1)^{k}, wherein k is the number of sensors and r is the number of redundant sensors for each sensor.

26. The apparatus according to claim 17, said signal processing unit (53) being further configured to monitor, for each sensor, a number of features corresponding to a number of consecutive exposures and to invalidate one of the features based on a result of a majority voting performed on the number of features.

27. The apparatus according to claim 17, said data processing unit (55) being further configured to reduce the dimensionality of the feature vectors by performing one of a Principal Component Analysis (PCA), a Linear Discriminant Analysis (LDA), and a Kernel Discriminant Analysis (KDA).

28. The apparatus according to claim 17, further comprising a pattern recognition unit (65) coupled to the data processing unit and being configured to recognize patterns based on the feature vectors.

29. The apparatus according to claim 28, said pattern recognition unit (65) comprising at least one of a module to perform a k-nearest neighbor algorithm on the feature vectors, a multi layer perceptron (MLP) artificial neural network (ANN) with back propagation learning, and a multi-class kernel Support Vector Machine (SVM) used with data obtained by multi kernel learning (MKL).

30. A system for feature extraction, comprising:
a sensor array including a plurality of sensors; and
an apparatus according to claim 17, said apparatus being coupled to the sensor array and configured to extract features from signals of sensors of the sensor array.

31. The system of claim 30, wherein the sensor array comprises gas sensors.

32. The system of claim 30 or 31, wherein at least some of the gas sensors include composites of metal nanoparticles and organic linkers.
